(19) United States
(12) Patent Application Publication
(10) Pub. No.: US 2023/0253651 A1
(43) Pub. Date: Aug. 10, 2023

(54) SECONDARY BATTERY

(71) Applicant: MURATA MANUFACTURING CO., LTD., Kyoto (JP)

(72) Inventors: Kunio SODEYAMA, Kyoto (JP); Kosuke YANAGIDA, Kyoto (JP); Shunya MIYAZAKI, Kyoto (JP)

(21) Appl. No.: 18/135,581

(22) Filed: Apr. 17, 2023

Related U.S. Application Data
(63) Continuation of application No. PCT/JP2021/032811, filed on Sep. 7, 2021.

(30) Foreign Application Priority Data
Oct. 21, 2020 (JP) 2020-176941

(51) Int. Cl. H01M 50/186; H01M 50/147; H01M 10/0525

(52) U.S. Cl. CPC H01M 50/186; H01M 50/147; H01M 10/0525

(57) ABSTRACT

A secondary battery includes a container member, a battery device, a cover member, and a sealing member. The container member includes a bent part defining an open end part. The battery device is contained inside the container member. The cover member closes the open end part. The sealing member is interposed between the bent part and the cover member. The cover member includes a first bottom surface, a first top surface, and a first side surface. The first bottom surface is opposed to the battery device. The first top surface is positioned on an opposite side to the first bottom surface. The first side surface is coupled to each of the first bottom surface and the first top surface. The bent part is provided along the first bottom surface, the first side surface, and the first top surface in this order and includes a tip part. The tip part is provided along the first side surface and the first top surface in this order. The container member has an outer diameter of greater than or equal to 25 mm and less than or equal to 27 mm in an intersecting direction. The outer diameter is defined based on the bent part. The intersecting direction intersects with a placing direction in which the battery device is placed into the container member. A proportion of a length of the tip part in the intersecting direction to the outer diameter of the container member is greater than or equal to 8.0% and less than or equal to 10.0%.

### CROSS REFERENCE TO RELATED APPLICATIONS

The present application is a continuation of PCT patent application no. PCT/JP2021/032811, filed on Sep. 7, 2021, which claims priority to Japanese patent application no. JP2020-176941, filed on Oct. 21, 2020, the entire contents of which are incorporated herein by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a battery device inside a container member. A configuration of a battery such as the secondary battery has been considered in various ways.

Specifically, in order to improve sealability of the container member, a condition such as an amount of a covered portion of a can related to the container member is defined.

In order to prevent liquid leakage of an alkaline battery of a cylindrical type, a surface roughness of an inner surface (a portion in contact with a gasket and a portion in contact with a positive electrode acting material) of a positive electrode container is defined. In order to prevent liquid leakage of an alkaline manganese battery, a surface roughness Ra of an inner surface (an inner surface of a main portion of a sidewall and an inner surface of a crimp part) of a battery can is defined. In order to achieve a battery case having superior pressure resistance at a sealing opening part, an inner surface roughness of a metal case (a body part and an opening part) is defined. In order to achieve a lithium battery having an enhanced sealing property, a sealing agent including coal tar pitch as a main component is interposed at a location where a gasket and an outer package can are in contact with each other. In order to improve a liquid leakage resistance property of an alkaline battery, a dimethyl silicone oil is applied to an exposed part of an insulating gasket.

### SUMMARY

The present technology relates to a secondary battery.

Although consideration has been given in various ways in relation to various characteristics of a secondary battery, safety of the secondary battery is not sufficient yet. Accordingly, there is still room for improvement in terms thereof.

It is therefore desirable to provide a secondary battery that is able to achieve superior safety.

A secondary battery according to the present technology includes a container member, a battery device, a cover member, and a sealing member. The container member includes a bent part defining an open end part. The battery device is contained inside the container member. The cover member closes the open end part. The sealing member is interposed between the bent part and the cover member. The cover member includes a first bottom surface, a first top surface, and a first side surface. The first bottom surface is opposed to the battery device. The first top surface is positioned on an opposite side to the first bottom surface. The first side surface is coupled to each of the first bottom surface and the first top surface. The bent part is bent to lie along the first bottom surface, the first side surface, and the first top surface in this order and includes a tip part. The tip part is bent to lie along the first side surface and the first top surface in this order. The container member has an outer diameter of greater than or equal to 25 mm and less than or equal to 27 mm in an intersecting direction. The outer diameter is defined based on the bent part. The intersecting direction intersects with a placing direction in which the battery device is placed into the container member. A proportion of a length of the tip part in the intersecting direction to the outer diameter of the container member is greater than or equal to 8.0% and less than or equal to 10.0%.

According to the secondary battery of the technology, the outer diameter of the container member is greater than or equal to 25 mm and less than or equal to 27 mm, and the proportion of the length of the tip part to the outer diameter of the container member is greater than or equal to 8.0% and less than or equal to 10.0%. Accordingly, it is possible to achieve superior safety.

Note that effects of the present technology are not necessarily limited to those described herein and may include any suitable effect.

### BRIEF DESCRIPTION OF THE FIGURES

FIG. 1 is a sectional view of a configuration of a secondary battery according to an embodiment of the present technology.

FIG. 2 is a sectional view of a portion of the configuration of the secondary battery illustrated in FIG. 1.

FIG. 3 is an enlarged sectional view of a configuration of a crimp structure illustrated in FIG. 2.

FIG. 4 is an enlarged sectional view of a configuration of a gasket illustrated in FIG. 3.

FIG. 5 is an enlarged sectional view of a portion of a configuration of a battery device illustrated in FIG. 1.

FIG. 6 is a sectional view for describing an operation of the secondary battery.

FIG. 7 is a sectional view for describing the operation of the secondary battery, following FIG. 6.

FIG. 8 is a sectional view for describing a process of manufacturing the secondary battery.

FIG. 9 is a sectional view for describing the process of manufacturing the secondary battery, following FIG. 8.

FIG. 10 is a block diagram illustrating a configuration of an application example of the secondary battery, which is a battery pack.

### DETAILED DESCRIPTION

One or more embodiments of the present technology are described below in further detail including with reference to the drawings.

A description is given first of a secondary battery according to an embodiment of the present technology.

Although a charge and discharge principle of the secondary battery to be described below is not particularly limited, the following description deals with a case where a battery capacity is obtained using insertion and extraction of an electrode reactant.

The secondary battery includes a positive electrode, a negative electrode, and an electrolyte. In the secondary battery, a charge capacity of the negative electrode is greater than a discharge capacity of the positive electrode. In other words, an electrochemical capacity per unit area of the negative electrode is greater than an electrochemical capacity per unit area of the positive electrode. This is to prevent precipitation of the electrode reactant on a surface of the negative electrode during charging.

Although not particularly limited in kind, the electrode reactant is specifically a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains the battery capacity using insertion and extraction of lithium is a so-called lithium-ion secondary battery. In the lithium-ion secondary battery, lithium is inserted and extracted in an ionic state.

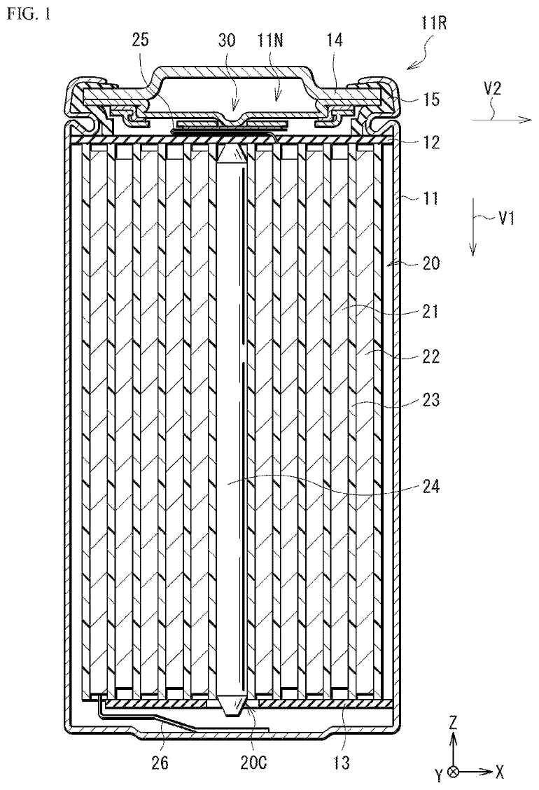

FIG. 1 illustrates a sectional configuration of the secondary battery. The secondary battery is a secondary battery in which a battery device 20 is contained inside a battery can 11 having a cylindrical shape as illustrated in FIG. 1, that is, a so-called secondary battery of a cylindrical type.

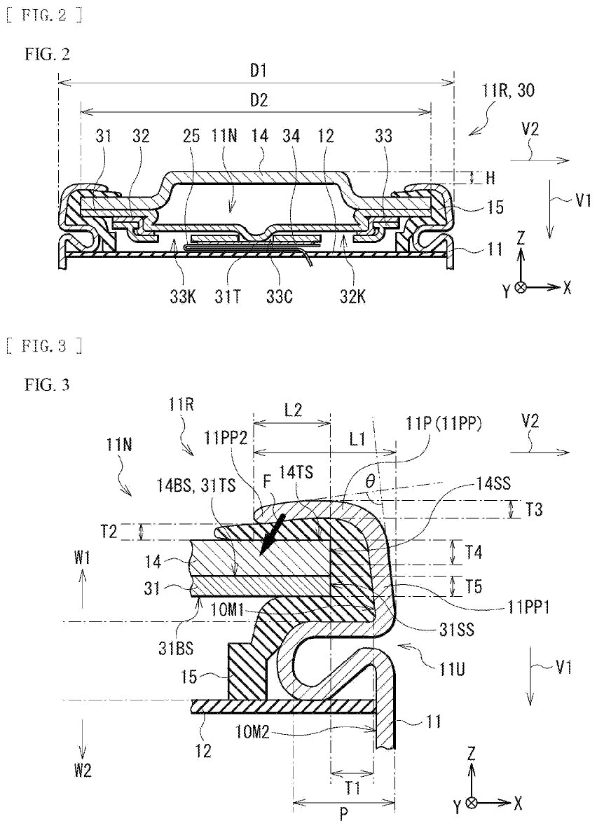

The secondary battery of the cylindrical type described below is, in particular, a large-diameter secondary battery having outer diameters D1 and D2 that are each relatively large. For the outer diameters D1 and D2, see FIG. 2. The outer diameters D1 and D2 will be described later.

Hereinafter, a direction in which the battery device 20 is placed into the battery can 11, i.e., a Z-axis direction in FIG. 1, is referred to as a “placing direction V1”, and a direction intersecting with the placing direction V1, i.e., an X-axis direction in FIG. 1, is referred to as an “intersecting direction V2”.

Specifically, the secondary battery includes a pair of insulating plates 12 and 13 and the battery device 20 inside the battery can 11. The secondary battery also includes a battery cover 14 and a gasket 15 that are attached to the battery can 11. Note that the secondary battery may further include unillustrated components including, without limitation, a thermosensitive resistive (PTC) device and a reinforcing member inside the battery can 11.

The battery can 11 is a container member that contains the battery device 20 and other components. The battery can 11 is a cylindrical container with one end part open and another end part closed, and extends in the placing direction V1. That is, the battery can 11 has an open end part 11N which is the one end part open.

The battery can 11 includes one or more of electrically conductive materials including, without limitation, a metal material. Specific examples of the metal material include iron, aluminum, and stainless steel. However, specific examples of the metal material may include an alloy of one or more of metals including, without limitation, iron and aluminum. The battery can 11 may have a surface plated with one or more of metal materials including, without limitation, nickel.

The insulating plates 12 and 13 each extend in the intersecting direction V2, and are disposed to be opposed to each other with the battery device 20 interposed therebetween in the placing direction V1.

The battery cover 14 and the safety valve mechanism 30 are crimped at the open end part 11N of the battery can 11 with the gasket 15 interposed between the open end part 11N and both the battery cover 14 and the safety valve mechanism 30. The battery can 11 thus includes a bent part 11P defining the open end part 11N, as will be described later. For the bent part 11P, see FIG. 3.

The open end part 11N of the battery can 11 is sealed by the battery cover 14 in a state where the battery device 20 and other components are contained inside the battery can 11. Thus, in the battery can 11, the bent part 11P defining the open end part 11N and both the battery cover 14 and the safety valve mechanism 30 are crimped to each other with the gasket 15 interposed therebetween to form a crimp structure 11R. As the bent part 11P is a so-called crimp part, the crimp structure 11R is a so-called crimp structure. A detailed configuration of the crimp structure 11R will be described with reference to FIG. 3.

The battery cover 14 is a cover member that closes the open end part 11N of the battery can 11. The battery cover 14 includes a material similar to the material included in the battery can 11. However, the battery cover 14 may include a material different from the material included in the battery can 11.

In particular, the battery cover 14 preferably includes stainless steel. A reason for this is that this secures physical strength of the battery cover 14 and accordingly secures physical strength of the crimp structure 11R, suppressing falling off of the battery cover 14 and leakage of the electrolytic solution even if an internal pressure of the battery can 11 increases. Specific examples of the stainless steel include SUS304 and SUS430.

A middle part of the battery cover 14 is bent to protrude in a direction away from the battery device 20, i.e., in an upper direction. A portion other than the middle part, that is, a peripheral part, of the battery cover 14 is thus adjacent to the safety valve mechanism 30 (a safety cover 31 which will be described later).

The gasket 15 is a sealing member that is interposed between the battery can 11 (the bent part 11P) and the battery cover 14 to thereby seal a gap between the bent part 11P and the battery cover 14.

The gasket 15 includes one or more of insulating materials. Specific examples of the insulating materials include a polymer material such as polybutylene terephthalate (PBT) or polypropylene (PP). In particular, the gasket 15 preferably includes polypropylene. A reason for this is that the gap between the bent part 11P and the battery cover 14 is sufficiently sealed while the battery can 11 and the battery cover 14 are electrically separated from each other.

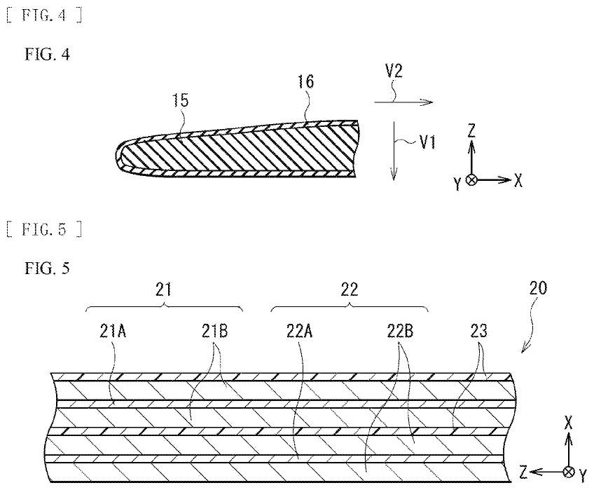

Note that the secondary battery may include a protective layer 16 covering a surface of the gasket 15, as will be described later. For the protective layer 16, see FIG. 4. A detailed configuration of the protective layer 16 will be described later.

The safety valve mechanism 30 is a mechanism that releases the internal pressure of the battery can 11 by causing the battery can 11 to be unsealed on an as-needed basis when the internal pressure of the battery can 11 increases. A cause of the increase in the internal pressure of the battery can 11 is, for example, a gas generated due to a decomposition reaction of the electrolytic solution during charging and discharging. A detailed configuration of the safety valve mechanism 30 will be described later with reference to FIG. 2.

The battery device 20 is contained inside the battery can 11, and includes a positive electrode 21, a negative electrode 22, and an electrolytic solution which is a liquid electrolyte.

Here, the battery device 20 is a so-called wound electrode body. That is, in the battery device 20, the positive electrode 21 and the negative electrode 22 are stacked on each other with the separator 23 interposed therebetween, and the stack of the positive electrode 21, the negative electrode 22, and the separator 23 is wound. The positive electrode 21, the negative electrode 22, and the separator 23 are each impregnated with the electrolytic solution.

The battery device 20 has, at the center thereof, a space (a center space 20C) resulting from winding the positive electrode 21, the negative electrode 22, and the separator 23. A center pin 24 is disposed in the center space 20C. However, the center pin 24 may be omitted.

A positive electrode lead 25 is coupled to the positive electrode 21, and a negative electrode lead 26 is coupled to the negative electrode 22. The positive electrode lead 25 includes one or more of electrically conductive materials including, without limitation, a metal material. Specific examples of the metal material include aluminum. The positive electrode lead 25 is electrically coupled to the battery cover 14 via the safety valve mechanism 30. The negative electrode lead 26 includes one or more of electrically conductive materials including, without limitation, a metal material. Specific examples of the metal material include nickel. The negative electrode lead 26 is electrically coupled to the battery can 11.

A detailed configuration of the battery device 20, i.e., a detailed configuration of each of the positive electrode 21, the negative electrode 22, the separator 23, and the electrolytic solution will be described later with reference to FIG. 5.

FIG. 2 illustrates a portion of a sectional configuration of the secondary battery illustrated in FIG. 1, and more specifically, illustrates the safety valve mechanism 30 and other components.

The safety valve mechanism 30 includes the safety cover 31, a disk holder 32, a stripper disk 33, and a sub-disk 34, as illustrated in FIG. 2. The safety cover 31, the disk holder 32, the stripper disk 33, and the sub-disk 34 are disposed in this order from a side closer to the battery cover 14.

As will be described later, the safety cover 31 is an adjacent member adjacent to the battery cover 14 (a bottom surface 14BS which will be described later), and is able to open in part in response to an increase in the internal pressure of the battery can 11. In a case where the safety cover 31 opens in part, the safety cover 31 may cleave in part, or may be removed in part. The safety cover 31 includes one or more of electrically conductive materials including, without limitation, a metal material. Specific examples of the metal material include aluminum and an aluminum alloy.

A planar shape of the safety cover 31 is not particularly limited, and is specifically circular, for example. The “planar shape” refers to a shape in a plane along an XY plane. Hereinafter, the above-described definition of the planar shape is similarly applicable. A middle part of the safety cover 31 is bent to protrude toward the disk holder 32. Such a middle part of the safety cover 31 includes a protruding part 31T that protrudes toward the disk holder 32 in part.

The disk holder 32 is a member that is interposed between the safety cover 31 and the stripper disk 33 to align the stripper disk 33 with respect to the safety cover 31. The disk holder 32 includes one or more of insulating materials including, without limitation, a polymer material. Specific examples of the polymer material include polypropylene (PP) and polybutylene terephthalate (PBT).

A planar shape of the disk holder 32 is not particularly limited, and is specifically circular, for example. A middle part of the disk holder 32 is bent to be recessed in a direction away from the safety cover 31. The disk holder 32 thus includes a recessed part. The middle part of the safety cover 31 is fitted into the recessed part of the disk holder 32. The middle part of the disk holder 32 has an opening 32K at a location corresponding to the middle part of the safety cover 31. An opening shape of the opening 32K is not particularly limited, and is specifically circular, for example.

The stripper disk 33 is a member that releases a gas generated inside the battery can 11. The stripper disk 33 includes one or more of electrically conductive materials including, without limitation, a metal material. Specific examples of the metal material include aluminum and an aluminum alloy.

A planar shape of the stripper disk 33 is not particularly limited, and is specifically circular, for example. A middle part of the stripper disk 33 is bent to be recessed in a direction away from the disk holder 32. The stripper disk 33 thus includes a recessed part. The middle part of the disk holder 32 is fitted into the recessed part of the stripper disk 33. The middle part of the stripper disk 33 has openings 33C and 33K.

The opening 33C is a lead-out opening that allows the protruding part 31T of the safety cover 31 to be led out therefrom, thereby allowing the protruding part 31T to be in contact with the sub-disk 34. An opening shape of the opening 33C is not particularly limited, and is specifically circular, for example.

The opening 33K is a vent for releasing the gas generated inside the battery can 11 to an outside. Although the number of openings 33K is not particularly limited, a plurality of openings 33K are preferably provided, in particular. A reason for this is that the gas is released easily with use of the openings 33K. The openings 33K are provided at respective concentric positions around the opening 33C. An opening shape of the opening 33K is not particularly limited, and is specifically circular, for example.

### [Sub-Disk]

The sub-disk 34 is a member that is interposed between the safety cover 31 and the positive electrode lead 25 to electrically couple the safety cover 31 (the protruding part 31T) to the positive electrode lead 25. The sub-disk 34 includes one or more of electrically conductive materials including, without limitation, a metal material. Specific examples of the metal material include aluminum and an aluminum alloy. A planar shape of the sub-disk 34 is not particularly limited, and is specifically circular, for example.

The PTC device is disposed between the battery cover 14 and the safety cover 31, and is electrically coupled to each of the battery cover 14 and the safety cover 31. The PTC device is thus crimped together with the battery cover 14 and the safety cover 31 by means of the gasket 15. The PTC device includes a resistor (a thermistor) whose electric resistance greatly changes in response to a change in temperature. The electric resistance of the PTC device rapidly increases when an internal temperature of the secondary battery exceeds a predetermined temperature, in order to prevent abnormal heat generation of the secondary battery due to a large current. The safety valve mechanism 30 is electrically coupled to the battery cover 14 via the PTC device.

As with the PTC device, the reinforcing member is disposed between the battery cover 14 and the safety cover 31, and is crimped together with the battery cover 14 and the safety cover 31 by means of the gasket 15. The reinforcing member includes one or more of electrically conductive materials including, without limitation, a metal material. Specific examples of the metal material include copper, aluminum, and iron. Note that the reinforcing member may have a surface plated with one or more of metal materials including, without limitation, nickel.

FIG. 3 illustrates, in an enlarged manner, a sectional configuration of the crimp structure 11R illustrated in FIG. 2. FIG. 4 illustrates, in an enlarged manner, a sectional configuration of the gasket 15 illustrated in FIG. 3. In the following, reference is also made to FIGS. 1 and 2 in addition to FIGS. 3 and 4 where appropriate.

In the secondary battery, as described above, the bent part 11P defining the open end part 11N and both the battery cover 14 and the safety valve mechanism 30 are crimped to each other by means of the gasket 15 in the battery can 11 to provide the crimp structure 11R, as illustrated in FIG. 3.

Specifically, the battery can 11 includes the bent part 11P, as described above. The bent part 11P is a portion resulting from bending the battery can 11 (the open end part 11N) in such a manner as to have a predetermined bent shape in order to provide the crimp structure 11R. The predetermined bent shape will be described later.

The battery cover 14 extends in the intersecting direction V2 to close the open end part 11N of the battery can 11. The battery cover 14 includes: the bottom surface 14BS that is a first bottom surface opposed to the battery device 20; a top surface 14TS that is a first top surface positioned on an opposite side to the bottom surface 14BS; and a side surface 14SS that is a first side surface coupled to each of the bottom surface 14BS and the top surface 14TS.

In order to provide the crimp structure 11R, the bent part 11P is bent to lie along the bottom surface 14BS, the side surface 14SS, and the top surface 14TS in this order in a state where the gasket 15 is interposed between the bent part 11P and the battery cover 14. Thus, the bent part 11P includes a tip part 11PP that is bent to lie along the side surface 14SS and the top surface 14TS in this order. Accordingly, the gasket 15 is bent to lie along the bottom surface 14BS, the side surface 14SS, and the top surface 14TS in this order in a manner similar to that of the bent part 11P.

Thus, the tip part 11PP, which is a portion of the bent part 11P, is bent in the intersecting direction V2 to overlap with the top surface 14TS of the battery cover 14 with the gasket 15 interposed therebetween. In other words, the tip part 11PP and the battery cover 14 overlap with each other in the placing direction V1.

In addition, the remaining portion (a portion other than the tip part 11PP) of the bent part 11P is bent in the intersecting direction V2 to overlap with the bottom surface 14BS of the battery cover 14 with the gasket 15 interposed therebetween. The battery can 11 thus includes a recessed part 11U. The recessed part 11U is a portion at which the bent part 11P is folded back in part to lie along the bottom surface 14BS. A depth P of the recessed part 11U is not particularly limited, and may be set as desired.

Thus, the bent part 11P, which is a portion (the open end part 11N) of the battery can 11, is bent to have the above-described bent shape. In this case, the bent part 11P presses the gasket 15 against the battery cover 14, and sandwiches the battery cover 14 from an upper side and a lower side with the gasket 15 interposed therebetween. Accordingly, the gap between the bent part 11P and the battery cover 14 is sealed by the gasket 15, and the battery cover 14 is fixed to the battery can 11 with the gasket 15 interposed therebetween. The crimp structure 11R is thus provided.

Here, as described above, the safety valve mechanism 30 is attached to the battery cover 14, and the safety cover 31 is therefore adjacent to the battery cover 14. Specifically, although the middle part of the battery cover 14 is bent to be spaced away from the middle part of the safety cover 31, the peripheral part of the battery cover 14 is adjacent to a peripheral part of the safety cover 31.

As with the battery cover 14, the safety cover 31 extends in the intersecting direction V2. Thus, the safety cover 31 includes: a bottom surface 31BS that is a second bottom surface opposed to the battery device 20; a top surface 31TS that is a second top surface adjacent to the bottom surface 14BS; and a side surface 31SS that is a second side surface coupled to each of the bottom surface 31BS and the top surface 31TS. As described above, the peripheral part of the battery cover 14 is adjacent to the peripheral part of the safety cover 31, and the bottom surface 14BS of the battery cover 14 is therefore adjacent to the top surface 31TS of the safety cover 31.

In this case, the bent part 11P is bent to lie along the bottom surface 31BS, the side surface 31SS, the side surface 14SS, and the top surface 14TS in this order in a state where the gasket 15 is interposed between the bent part 11P and both the battery cover 14 and the safety cover 31. Therefore, the gasket 15 is bent to lie along the bottom surface 31BS, the side surface 31SS, the side surface 14SS, and the top surface 14TS in this order in a manner similar to that of the bent part 11P.

Thus, the bent part 11P presses the gasket 15 against each of the battery cover 14 and the safety cover 31, and sandwiches the battery cover 14 and the safety cover 31 from the upper side and the lower side with the gasket 15 interposed therebetween. Accordingly, the gap between the bent part 11P and each of the battery cover 14 and the safety cover 31 is sealed by the gasket 15, and the battery cover 14 and the safety cover 31 are fixed to the battery can 11 with the gasket 15 interposed therebetween.

A thickness of the gasket 15 is not particularly limited. In particular, because the gasket 15 is bent to lie along the side surface 14SS and the top surface 14TS in this order, it is preferable that the thickness of the gasket 15 be reduced gradually as the gasket 15 lies along from the side surface 14SS toward the top surface 14TS. A reason for this is that this allows the gap between the bent part 11P and the battery cover 14 to be sealed easily by the gasket 15 with use of force of the bent part 11P pressing the gasket 15 against the battery cover 14, i.e., pressing force F.

Accordingly, a portion, of the bent part 11P, extending along the side surface 14SS, i.e., an inclined part 11PP1 which will be described later, may be inclined in accordance with the above-described reduction in the thickness of the gasket 15. That is, the portion, of the bent part 11P, extending along the side surface 14SS may gradually be closer to the battery cover 14 as the portion extends along from the side surface 14SS toward the top surface 14TS.

A position of a tip of the gasket 15 is not particularly limited. In particular, the tip of the gasket 15 preferably protrudes relative to a tip of the bent part 11P. A reason for this is that this allows the gap between the bent part 11P and the battery cover 14 to be sealed easily by the gasket 15 with use of the above-described pressing force F also in the vicinity of the tip of the bent part 11P.

In addition, a position of an upper end of the bent part 11P is not particularly limited. In particular, the position of the upper end of the bent part 11P is preferably lower than a position of an upper end of the battery cover 14. In other words, the upper end of the bent part 11P is preferably positioned on a side closer to the battery device 20 than the upper end of the battery cover 14 in the placing direction V1. A reason for this is that this provides a distance H between the upper end of the bent part 11P and the upper end of the battery cover 14, and thus secures a space to provide an unillustrated external tab. Accordingly, the external tab is easily coupled to the battery cover 14 serving as an external coupling terminal of the positive electrode 21.

As illustrated in FIG. 4, the gasket 15 includes the surface covered with the protective layer 16, and the protective layer 16 may include asphalt. A reason for this is that this allows the gap between the bent part 11P and the battery cover 14 to be sealed easily by the gasket 15, as compared with a case where the surface of the gasket 15 is not covered with the protective layer 16.

The protective layer 16 is formed by applying a paste including a solvent and asphalt to the surface of the gasket 15, and is thus formed to cover the surface of the gasket 15. An area density (mg/cm²), which is a formation amount (an application amount), of the protective layer 16, is not particularly limited, and is preferably within a range from 0.060 mg/cm² to 0.100 mg/cm² both inclusive, in particular. A reason for this is that manufacturability (manufacture efficiency) of the secondary battery is secured even if the protective layer 16 (asphalt) having adhesiveness is used, while a sealing property of the gasket 15 is secured.

Regarding the secondary battery, a configuration condition related to the crimp structure 11R is made appropriate in order to achieve superior safety. In the following, reference is made to FIGS. 2 and 3.

Specifically, as described above, the secondary battery described here is a large-diameter secondary battery. The outer diameter D1 (mm) of the battery can 11 defined based on the bent part 11P in the intersecting direction V2 is therefore within a range from 25 mm to 27 mm both inclusive.

In this case, a bending proportion R1 (%) that is a proportion of a length L1 (mm) of the tip part 11PP in the intersecting direction V2 to the above-described outer diameter D1 is within a range from 8.0% to 10.0% both inclusive. The bending proportion R1 is calculated based on the following calculation expression: R1=(L1/D1)×100.

The “outer diameter D1” of the battery can 11 described here is a so-called maximum outer diameter. A reason for this is that, in a case where the portion, of the bent part 11P, extending along the side surface 14SS, i.e., the inclined part 11PP1 which will be described later, is inclined in accordance with the reduction in the thickness of the gasket 15 as described above, the outer diameter D1 of the battery can 11 defined based on such a bent part 11P may vary depending on a location (a position where measurement is performed).

The length L1 is not particularly limited as long as the above-described appropriate condition related to the bending proportion R1 is satisfied. In particular, the length L1 is preferably within a range from 2.1 mm 2.6 mm both inclusive. A reason for this is that the range of the length L1 is made appropriate with respect to the range of the outer diameter D1, and the appropriate condition related to the bending proportion R1 is therefore easily satisfied.

A reason why the appropriate condition related to the bending proportion R1 is satisfied is that a relationship between the outer diameter D1 and the length L is made appropriate in a case where the outer diameter D1 is within the above-described range to improve safety of the secondary battery.

Specifically, in a case where the appropriate condition related to the bending proportion R1 is not satisfied, it is difficult for the gap between the bent part 11P and the battery cover 14 to be sealed by the gasket 15.

If the bending proportion R1 is less than 8.0%, the length L1 is too small with respect to the outer diameter D1, and the pressing force F thus becomes insufficient in the first place. This easily produces the gap between the bent part 11P and the battery cover 14, making it more difficult for the gap to be sealed by the gasket 15.

If the bending proportion R1 is greater than 10.0%, the length L1 is too large with respect to the outer diameter D1, and therefore, when the bent part 11P is bent in a process of forming the crimp structure 11R, the bent part 11P easily becomes wavy in the vicinity of its tip. “Becoming wavy” refers to a phenomenon in which the bent part 11P deforms to be wavy in the vicinity of its tip. In this case, although the length L1 is sufficiently large with respect to the outer diameter D1, the pressing force F decreases in the vicinity of the tip of the bent part 11P. This easily produces the gap between the bent part 11P and the battery cover 14 due to external force such as an impact at the time when the secondary battery is dropped, making it more difficult for the gap to be sealed by the gasket 15.

In contrast, if the bending proportion R1 is within the range from 8.0% to 10.0% both inclusive, the bending length L1 is made appropriate with respect to the outer diameter D1. Therefore, the bent part 11P is prevented from easily becoming wavy in the vicinity of its tip while the pressing force F is secured. This prevents a gap from being easily produced between the bent part 11P and the battery cover 14, allowing the gap to be sealed easily by the gasket 15. Accordingly, the sealing strength of the crimp structure 11R improves, and an effective operation of the safety valve mechanism 30 is therefore secured. That is, the safety valve mechanism 30 does not operate until the internal pressure of the battery can 11 sufficiently increases, and operates when the internal pressure of the battery can 11 sufficiently increases.

As described above, if the bending proportion R1 satisfies the appropriate condition, the effective operation of the safety valve mechanism 30 is secured, and the safety of the secondary battery therefore improves.

Other than the above, another configuration condition related to the crimp structure 11R may be made appropriate, as will be described below.

As described above, the secondary battery described here is a large-diameter secondary battery. The outer diameter D2 (mm) of the battery cover 14 in the intersecting direction V2 is therefore within a range from 24 mm to 26 mm both inclusive.

The tip part 11PP and the battery cover 14 overlap with each other in the placing direction V1, as described above. In this case, an overlap proportion R2 (%) is not particularly limited, and is preferably within a range from 4.0% to 6.0% both inclusive, in particular. The overlap proportion R2 is a proportion of a length L2 (mm), in the intersecting direction V2, of a range in which the tip part 11PP and the battery cover 14 overlap with each other to the above-described outer diameter D2. The overlap proportion R2 is calculated based on the following calculation expression: R2=(L2/D2)×100.

The length L2 is not particularly limited as long as the above-described appropriate condition related to the overlap proportion R2 is satisfied. In particular, the length L2 is preferably within a range from 1.0 mm 1.5 mm both inclusive. A reason for this is that the range of the length L2 is made appropriate with respect to the range of the outer diameter D2, and the appropriate condition related to the overlap proportion R2 is therefore easily satisfied.

A reason why the appropriate condition related to the overlap proportion R2 is satisfied is that the safety of the secondary battery further improves.

Specifically, in a case where the appropriate condition related to the overlap proportion R2 is not satisfied, it is difficult for the battery cover 14 to be fixed to the battery can 11.

If the overlap R2 is less than 4.0%, the length L2 is too small with respect to the outer diameter D2, and it is therefore difficult for the bent part 11P to hold the battery cover 14 with the gasket 15 interposed therebetween in the first place. This makes it difficult for the battery cover 14 to be fixed to the battery can 11. As a result, the battery cover 14 easily falls off from the battery can 11, and the electrolytic solution easily flows out (leaks) from the inside of the battery can 11, due to external force such as the impact at the time when the secondary battery is dropped.

If the overlap proportion R2 is greater than 6.0%, the length L2 is too large with respect to the outer diameter D2, and the bent part 11P therefore easily becomes wavy in the vicinity of its tip. In this case, although the length L2 is sufficiently large with respect to the outer diameter D2, it is substantially difficult for the bent part 11P to hold the battery cover 14 with the gasket 15 interposed therebetween. This makes it difficult for the battery cover 14 to be fixed to the battery can 11. As a result, the battery cover 14 easily falls off and the electrolytic solution easily leaks.

In contrast, if the overlap proportion R2 is within the range from 4.0% to 6.0% both inclusive, the length L2 is made appropriate with respect to the outer diameter D2. This makes it easier for the bent part 11P to hold the battery cover 14 with the gasket 15 interposed therebetween, and prevents the bent part 11P from easily becoming wavy in the vicinity of its tip. It is thus easier for the battery cover 14 to be fixed to the battery can 11. As a result, the battery cover 14 is prevented from easily falling off, and the electrolytic solution is prevented from easily leaking.

As described above, if the appropriate condition related to the overlap proportion R2 is satisfied, the effective operation of the safety valve mechanism 30 is secured while the falling off of the battery cover 14 and the leakage of the electrolytic solution are suppressed. Accordingly, the safety of the secondary battery further improves.

As described above, in the case where the thickness of the gasket 15 is gradually reduced as the gasket 15 lies along from the side surface 14SS toward the top surface 14TS, the tip part 11PP is inclined to lie along the surface of the gasket 15 in accordance with the reduction in the thickness of the gasket 15.

Thus, the tip part 11PP includes the inclined part 11PP1 and an inclined part 11PP2. The inclined part 11PP1 is a first tip part extending along the side surface 14SS. The inclined part 11PP2 is a second tip part extending along the top surface 14TS, and is coupled to the inclined part 11PP1.

In this case, a crimp angle θ is not particularly limited, and is preferably within a range from 80° to 90° both inclusive, in particular. The crimp angle θ is an angle defined by a direction in which the inclined part 11PP1 extends and a direction in which the inclined part 11PP2 extends.

In a case where the thickness of the gasket 15 is gradually reduced and where the safety cover 31 is adjacent to the battery cover 14 as described above, a thickness difference DT (mm) is not particularly limited, and is preferably within a range from 0.10 mm to 0.29 mm both inclusive, in particular. The thickness difference DT results from subtracting a thickness T2 (mm) of the gasket 15 at a position corresponding to the tip of the bent part 11P in the intersecting direction V2 from a thickness T1 (mm) of the gasket 15 at a position corresponding to the bottom surface 31BS in the placing direction V1. The thickness difference DT is calculated based on the following calculation expression: DT=T1−T2.

Each of the thicknesses T1 and T2 is not particularly limited as long as the above-described appropriate condition related to the thickness difference DT is satisfied. In particular, the thickness T1 is preferably within a range from 0.47 mm to 0.66 mm both inclusive, and the thickness T2 is preferably within a range from 0.27 mm to 0.46 mm both inclusive. A reason for this is that the respective ranges of the thicknesses T1 and T2 are made appropriate with respect to the range of the crimp angle θ, and the appropriate condition related to the thickness difference DT is therefore easily satisfied.

A reason why the appropriate condition related to each of the crimp angle θ and the thickness difference DT is satisfied is that this allows the external tab to be easily coupled to the battery cover 14 while securing the safety of the secondary battery.

If the thickness difference DT is less than 0.10 μm in a case where the thickness T1 is fixed, the thickness in the vicinity of the tip of the gasket 15 is too large, and the distance H therefore becomes markedly small. Accordingly, a space for coupling the external tab to the battery cover 14 can be insufficient, which can make it difficult for the external tab to be coupled to the battery cover 14.

If the thickness difference DT is greater than 0.29 μm in the case where the thickness T1 is fixed, the thickness in the vicinity of the tip of the gasket 15 is too small, and the gasket 15 therefore easily breaks in the vicinity of its tip due to external force. As a result, the battery cover 14 can easily fall off and the electrolytic solution can easily leak due to external force.

In contrast, if the thickness difference DT is within the range from 0.10 μm to 0.29 μm both inclusive, the distance H becomes large. This secures the space for coupling the external tab to the battery cover 14 and prevents the gasket 15 from easily breaking in the vicinity of its tip, thus suppressing the falling off of the battery cover 14 and the leakage of the electrolytic solution. Accordingly, it is easier for the external tab to be coupled to the battery cover 14 while the safety of the secondary battery is secured.

A thickness T3 (mm) of the tip part 11PP is not particularly limited, and is preferably within a range from 0.27 mm to 0.31 mm both inclusive. A reason for this is that this allows the battery device 20 (the positive electrode 21 and the negative electrode 22) to have a sufficiently large size, therefore allowing the external tab to be easily coupled to the battery cover 14 while securing the battery capacity.

If the thickness T3 is less than 0.27 μm, the physical strength of the bent part 11P becomes insufficient. Therefore, it is difficult for the bent part 11P to hold the battery cover 14 with the gasket 15 interposed therebetween and the bent part 11P is easily deformed. As a result, when the internal pressure of the battery can 11 increases, the battery cover 14 can easily fall off and the electrolytic solution can easily leak.

If the thickness T3 is greater than 0.31 mm, in a case where a dimension (a height) of the battery can 11 in the placing direction V1 is fixed, a volume, of the inside of the battery can 11, occupied by the battery device 20 is reduced, and a charging and discharging area is therefore reduced. The “charging and discharging area” refers to an area of a region in which charging and discharging reactions are performable, and is an area of a so-called region where the positive electrode 21 and the negative electrode 22 are opposed to each other. An amount of charging and an amount of discharging can each decrease accordingly, and the battery capacity can therefore easily decrease.

In contrast, if the thickness T3 is within the range from 0.27 μm to 0.31 μm both inclusive, the physical strength of the bent part 11P is secured, and therefore, the falling off of the battery cover 14 and the leakage of the electrolytic solution are suppressed even if the internal pressure of the battery can 11 increases. In addition, the amount of charging and the amount of discharging each increase owing to an increase in the charging and discharging area, and the battery capacity therefore decreases. Accordingly, it is easier for the external tab to be coupled to the battery cover 14 while the battery capacity is secured.

A total thickness TT (mm) is not particularly limited, and is preferably within a range from 1.0 mm to 1.4 mm both inclusive, in particular. The total thickness TT results from adding a thickness T4 (mm) of the battery cover 14 and a thickness T5 (mm) of the safety cover 31 together. The total thickness TT is calculated based on the following calculation expression: TT=T4+T5.

Each of the thicknesses T4 and T5 is not particularly limited as long as the above-described appropriate condition related to the total thickness TT is satisfied. In particular, the thickness T4 is preferably within a range from 0.6 mm to 0.8 mm both inclusive, and the thickness T5 is preferably within a range from 0.4 mm to 0.6 mm both inclusive. A reason for this is that the respective ranges of the thicknesses T4 and T5 are made appropriate, and the appropriate condition related to the total thickness TT is therefore easily satisfied.

A reason why the appropriate condition related to the total thickness TT is satisfied is that this allows the external tab to be easily coupled to the battery cover 14 while securing the battery capacity.

If the total thickness TT is less than 1.0 mm, physical durability of the component such as the battery cover 14 closing the battery can 11 decreases, and the component such as the battery cover 14 is therefore easily deformed due to an increase in the internal pressure of the battery can 11. As a result, when the internal pressure of the battery can 11 increases, the battery cover 14 can easily fall off and the electrolytic solution can easily leak.

If the total thickness TT is greater than 1.4 mm, in the case where the dimension (the height) of the battery can 11 in the placing direction V1 is fixed, the volume, of the inside of the battery can 11, occupied by the battery device 20 is reduced, and the battery capacity can therefore easily decrease.

In contrast, if the total thickness TT is within the range from 1.0 mm to 1.4 mm both inclusive, the physical durability of the component such as the battery cover 14 improves, and therefore, the falling off of the battery cover 14 and the leakage of the electrolytic solution are suppressed even if the internal pressure of the battery can 11 increases. In addition, the volume, of the inside of the battery can 11, occupied by the battery device 20 increases, and the battery capacity therefore also increases. As a result, it is easier for the external tab to be coupled to the battery cover 14 while the battery capacity is secured.

An arithmetic mean roughness Ra of an inner wall of the battery can 11 is not particularly limited. The arithmetic mean roughness Ra of the inner wall of the battery can 11 is preferably different depending on locations, in particular.

Specifically, the battery can 11 includes inner walls 11M1 and 11M2 defined based on a position of the recessed part 11U as a reference. The inner wall 11M1 is an inner wall of the battery can 11 on a side (on an outer side W1) closer to the battery cover 14 relative to the position of the recessed part 11U as the reference in the placing direction V1. The inner wall 11M2 is an inner wall positioned on an opposite side to the inner wall 11M1 with the recessed part 11U interposed therebetween, that is, an inner wall of the battery can 11 on a side (on an inner side W2) farther from the battery cover 14 relative to the position of the recessed part 11U as the reference in the placing direction V1.

In this case, an arithmetic mean roughness Ra1 is preferably less than an arithmetic mean roughness Ra2. The arithmetic mean roughness Ra1 is the arithmetic mean roughness Ra of the inner wall 11M1. The arithmetic mean roughness Ra2 is the arithmetic mean roughness Ra of the inner wall 11M2.

Each of the arithmetic mean roughnesses Ra1 and Ra2 is not particularly limited as long as the above-described appropriate condition related to the arithmetic mean roughnesses Ra1 and Ra2 is satisfied. In particular, the arithmetic mean roughness Ra1 is preferably less than or equal to 0.4 and the arithmetic mean roughness Ra2 is preferably greater than 0.4 μm. A reason for this is that the respective ranges of the arithmetic mean roughnesses Ra1 and Ra2 are made appropriate, and the appropriate condition related to the arithmetic mean roughnesses Ra1 and Ra2 is therefore easily satisfied.

A reason why the appropriate condition related to the arithmetic mean roughnesses Ra1 and Ra2 is satisfied is that this suppresses leakage of the electrolytic solution while suppressing dissolution of the battery can 11.

Specifically, if the arithmetic mean roughness Ra1 is greater than the arithmetic mean roughness Ra2, and more specifically, if the arithmetic mean roughness Ra1 is greater than 0.4 multiple grooves are easily formed on a surface of the inner wall 11M1 on the outer side W1. The grooves serve as flow paths of the electrolytic solution. This causes the electrolytic solution to easily flow along the grooves. Accordingly, when the electrolytic solution is attached to the inner wall 11M1, the attached electrolytic solution can easily leak.

If the arithmetic mean roughness Ra2 is less than the arithmetic mean roughness Ra1, and more specifically, if the arithmetic mean roughness Ra2 is less than or equal to 0.4 μm, a surface of the inner wall 11M2 on the inner side W2 easily becomes smooth. Accordingly, when the electrolytic solution is attached to the inner wall 11M2, the attached electrolytic solution easily aggregates (is easily isolated), and the battery can 11 can therefore be easily dissolved.

In contrast, if the arithmetic mean roughness Ra1 is less than the arithmetic mean roughness Ra2, more specifically, if the arithmetic mean roughness Ra1 is less than or equal to 0.4 μm and the arithmetic mean roughness Ra2 is greater than 0.4 the grooves are not easily formed on the surface of the inner wall 11M1, and leakage of the electrolytic solution attached on the inner wall 11M1 is therefore prevented from easily occurring. In addition, the surface of the inner wall 11M2 does not become smooth easily, and dissolution of the battery can 11 by the electrolytic solution attached to the inner wall 11M2 is therefore prevented from easily occurring. Accordingly, the leakage of the electrolytic solution is suppressed while the dissolution of the battery can 11 is suppressed.

FIG. 5 illustrates, in an enlarged manner, a portion of a sectional configuration of the battery device 20 illustrated in FIG. 1. The battery device 20 includes the positive electrode 21, the negative electrode 22, the separator 23, and the electrolytic solution, as described above.

The positive electrode 21 includes, as illustrated in FIG. 5, a positive electrode current collector 21A and a positive electrode active material layer 21B.

The positive electrode current collector 21A has two opposed surfaces on each of which the positive electrode active material layer 21B is to be provided. The positive electrode current collector 21A includes an electrically conductive material such as a metal material. Specific examples of the metal material include aluminum.

Here, the positive electrode active material layer 21B is provided on each of the two opposed surfaces of the positive electrode current collector 21A. The positive electrode active material layer 21B includes one or more of positive electrode active materials into which lithium is insertable and from which lithium is extractable. Note that the positive electrode active material layer 21B may be provided only on one of the two opposed surfaces of the positive electrode current collector 21A, on a side on which the positive electrode 21 is opposed to the negative electrode 22. In addition, the positive electrode active material layer 21B may further include materials including, without limitation, a positive electrode binder and a positive electrode conductor. A method of forming the positive electrode active material layer 21B is not particularly limited, and is specifically a method such as a coating method.

The positive electrode active material includes a lithium compound. The lithium compound is a compound including lithium as a constituent element, and is more specifically a compound including lithium and one or more transition metal elements as constituent elements. A reason for this is that a high energy density is obtainable. Note that the lithium compound may further include one or more other elements (elements other than lithium and the transition metal elements) as one or more constituent elements.

The lithium compound is not limited to a particular kind, and specific examples thereof include a lithium composite oxide having a layered rock-salt crystal structure, a lithium composite oxide having a spinel crystal structure, and a lithium phosphoric acid compound having an olivine crystal structure. Specific examples of the lithium composite oxide having the layered rock-salt crystal structure include LiNiO₂ and LiCoO₂. Specific examples of the lithium composite oxide having the spinel crystal structure include LiMn₂O₄. Specific examples of the lithium phosphoric acid compound having the olivine crystal structure include LiFePO₄ and LiMnPO₄.

In particular, the positive electrode active material preferably includes the lithium phosphoric acid compound having the olivine crystal structure. A reason for this is that, because the crystal structure of the lithium phosphoric acid compound having the olivine crystal structure is thermally stable, the secondary battery is prevented from easily exhibiting thermal runaway due to a cause such as overcharging or an internal short circuit. Another reason is that, because the crystal structure of the lithium phosphoric acid compound having the olivine crystal structure is firm, the battery capacity is prevented from decreasing easily even if the secondary battery is charged and discharged repeatedly.

The positive electrode binder includes one or more of materials including, without limitation, a synthetic rubber and a polymer compound. Examples of the synthetic rubber include a styrene-butadiene-based rubber. Examples of the polymer compound include polyvinylidene difluoride.

The positive electrode conductor includes one or more of electrically conductive materials including, without limitation, a carbon material. Examples of the carbon material include graphite, carbon black, acetylene black, and Ketjen black. The electrically conductive material may be a metal material or a polymer compound, for example.

The negative electrode 22 includes, as illustrated in FIG. 5, a negative electrode current collector 22A and a negative electrode active material layer 22B.

The negative electrode current collector 22A has two opposed surfaces on each of which the negative electrode active material layer 22B is to be provided. The negative electrode current collector 22A includes an electrically conductive material such as a metal material. Specific examples of the metal material include copper.

Here, the negative electrode active material layer 22B is provided on each of the two opposed surfaces of the negative electrode current collector 22A. The negative electrode active material layer 22B includes one or more of negative electrode active materials into which lithium is insertable and from which lithium is extractable. Note that the negative electrode active material layer 22B may be provided only on one of the two opposed surfaces of the negative electrode current collector 22A, on a side on which the negative electrode 22 is opposed to the positive electrode 21. In addition, the negative electrode active material layer 22B may further include materials including, without limitation, a negative electrode binder and a negative electrode conductor. Details of the negative electrode binder are similar to those of the positive electrode binder. Details of the negative electrode conductor are similar to those of the positive electrode conductor. A method of forming the negative electrode active material layer 22B is not particularly limited, and specifically includes one or more of methods including, without limitation, a coating method, a vapor-phase method, a liquid-phase method, a thermal spraying method, and a firing (sintering) method.

The negative electrode active material includes a carbon material, a metal-based material, or both, for example. A reason for this is that a high energy density is obtainable. Examples of the carbon material include graphitizable carbon, non-graphitizable carbon, and graphite (natural graphite and artificial graphite). The metal-based material is a material that includes, as one or more constituent elements, one or more elements among metal elements and metalloid elements that are each able to form an alloy with lithium. Specific examples of such metal elements and metalloid elements include silicon, tin, or both. Note that the metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

The separator 23 is an insulating porous film interposed between the positive electrode 21 and the negative electrode 22 as illustrated in FIG. 5, and allows lithium ions to pass therethrough while preventing a short circuit between the positive electrode 21 and the negative electrode 22. The separator 23 includes a polymer compound such as polyethylene.

The electrolytic solution includes a solvent and an electrolyte salt. The solvent includes one or more of non-aqueous solvents (organic solvents) including, without limitation, a carbonic-acid-ester-based compound, a carboxylic-acid-ester-based compound, and a lactone-based compound. An electrolytic solution including any of the non-aqueous solvents is a so-called non-aqueous electrolytic solution. However, the solvent may be an aqueous solvent. The electrolyte salt includes one or more of light metal salts including, without limitation, a lithium salt. A content of the electrolyte salt is not particularly limited, and is preferably within a range from 0.3 mol/kg to 3.0 mol/kg both inclusive with respect to the solvent, in particular. A reason for this is that high ion conductivity is obtainable.

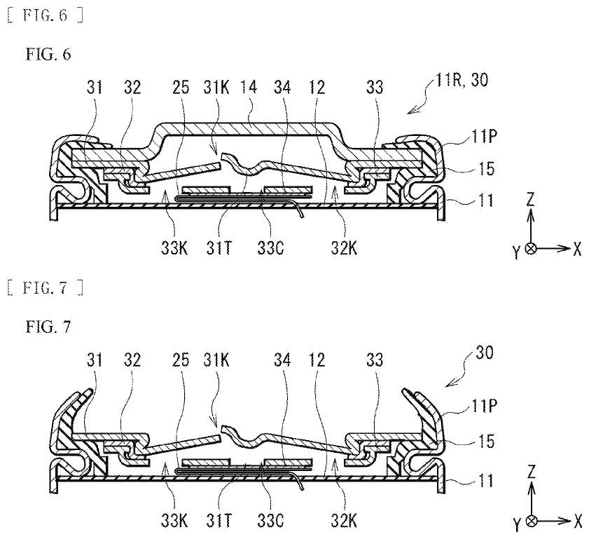

FIGS. 6 and 7 each illustrate a sectional configuration corresponding to FIG. 2 for describing an operation of the secondary battery (an operation at the time when the internal pressure increases, which will be described later).

In the following, an operation at the time of charging and discharging is described, and then, the operation at the time when the internal pressure increases is described. In this case, reference is also made to FIG. 2 in addition to FIGS. 6 and 7 where appropriate.

Upon charging, in the battery device 20, lithium is extracted from the positive electrode 21, and the extracted lithium is inserted into the negative electrode 22 via the electrolytic solution. Upon discharging, in the battery device 20, lithium is extracted from the negative electrode 22, and the extracted lithium is inserted into the positive electrode 21 via the electrolytic solution. Upon charging and discharging, lithium is inserted and extracted in an ionic state.

Upon charging and discharging of the secondary battery, when the internal pressure of the battery can 11 increases, the safety valve mechanism 30 operates in order to prevent the secondary battery, for example, from rupturing or being damaged.

Specifically, upon a normal operation of the secondary battery, the safety cover 31 is not yet open, as illustrated in FIG. 2. Therefore, although the stripper disk 33 has the opening 33K, the opening 33K (a gas releasing path) is closed by the safety cover 31.

When a gas is generated inside the battery can 11 due to a side reaction such as a decomposition reaction of the electrolytic solution, the generated gas is accumulated inside the battery can 11, and the internal pressure of the battery can 11 therefore increases. In this case, when the internal pressure of the battery can 11 reaches a certain level or higher, the safety cover 31 opens in part, as illustrated in FIG. 6. Accordingly, the protruding part 31T of the safety cover 31 is separated away from the sub-disk 34, which provides an opening 31K in the safety cover 31. This allows the gas releasing path using the opening 33K to be open. As a result, the gas generated inside the battery can 11 is released through the opening 33K.

Note that depending on the level of the internal pressure, the bent part 11P is deformed, and the crimp structure 11R is therefore destroyed. As a result, as illustrated in FIG. 7, the battery cover 14 falls off from the battery can 11, and the gas is thus released to the outside of the secondary battery.

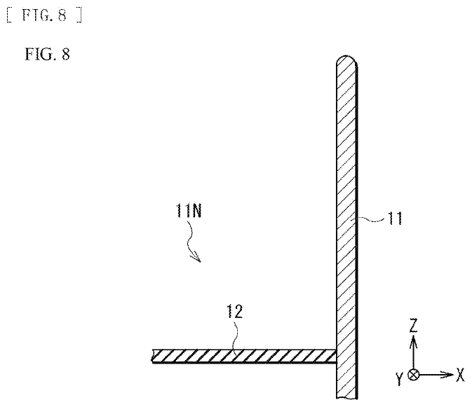

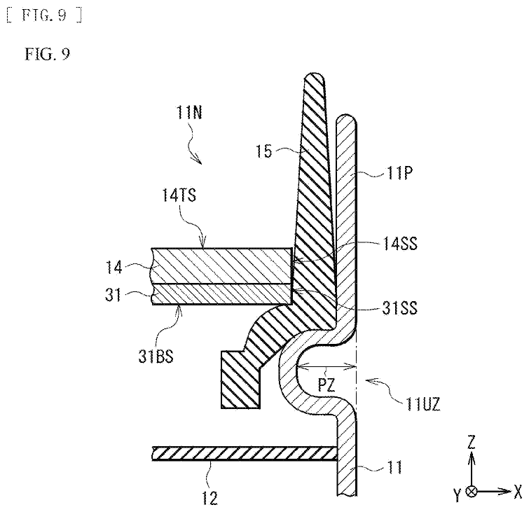

FIGS. 8 and 9 each illustrate a sectional configuration corresponding to FIG. 3 for describing a process of manufacturing the secondary battery.

First, the positive electrode active material is mixed with materials including, without limitation, the positive electrode binder and the positive electrode conductor on an as-needed basis to thereby obtain a positive electrode mixture. Thereafter, the positive electrode mixture is dispersed in a solvent to thereby obtain a positive electrode mixture slurry in a paste form. The solvent is not limited to a particular kind, and may therefore be an aqueous solvent or a non-aqueous solvent (an organic solvent). Thereafter, the positive electrode mixture slurry is applied on the two opposed surfaces of the positive electrode current collector 21A to thereby form the positive electrode active material layers 21B. Lastly, the positive electrode active material layers 21B may be compression-molded by means of, for example, a roll pressing machine. In this case, the positive electrode active material layers 21B may be heated. The positive electrode active material layers 21B may be compression-molded multiple times. In this manner, the positive electrode active material layers 21B are formed on the respective two opposed surfaces of the positive electrode current collector 21A. Thus, the positive electrode 21 is fabricated.

The negative electrode active material layers 22B are formed on the respective two opposed surfaces of the negative electrode current collector 22A by a procedure similar to that of the positive electrode 21 described above. Specifically, the negative electrode active material is mixed with materials including, without limitation, the negative positive electrode binder and the negative electrode conductor to thereby obtain a negative electrode mixture. Thereafter, the negative electrode mixture is dispersed in a solvent to thereby obtain a negative electrode mixture slurry in a paste form. Details of the solvent are as described above. Thereafter, the negative electrode mixture slurry is applied on the two opposed surfaces of the negative electrode current collector 22A to thereby form the negative electrode active material layers 22B. Lastly, the negative electrode active material layers 22B may be compression-molded by means of, for example, a roll pressing machine. Details of compression molding are as described above. In this manner, the negative electrode active material layers 22B are formed on the respective two opposed surfaces of the negative electrode current collector 22A. Thus, the negative electrode 22 is fabricated.

First, the positive electrode lead 25 is coupled to the positive electrode 21 (the positive electrode current collector 21A) by a method such as a welding method, and the negative electrode lead 26 is coupled to the negative electrode 22 (the negative electrode current collector 22A) by a method such as a welding method. Thereafter, the positive electrode 21 and the negative electrode 22 are stacked on each other with the separator 23 interposed therebetween, following which the stack of the positive electrode 21, the negative electrode 22, and the separator 23 is wound to thereby form a wound body having the center space 20C. The wound body has a configuration similar to that of the battery device 20 except that the positive electrode 21, the negative electrode 22, and the separator 23 are each not impregnated with the electrolytic solution. Thereafter, the center pin 24 is placed in the center space 20C of the wound body.

Thereafter, as illustrated in FIG. 8, the battery can 11 not yet provided with the recessed part 11U is prepared. Thereafter, the insulating plates 12 and 13 are opposed to each other with the wound body interposed therebetween, and the wound body, together with the insulating plates 12 and 13, is placed inside the battery can 11. In this case, the positive electrode lead 25 is coupled to the safety valve mechanism 30 by a method such as a welding method, and the negative electrode lead 26 is coupled to the battery can 11 by a method such as a welding method.

Thereafter, the battery can 11 is processed by means of a beading machine (a groove beading machine) to thereby provide a recessed part 11UZ in the battery can 11, as illustrated in FIG. 9. A depth PZ of the recessed part 11UZ provided here is smaller than a depth P of the recessed part 11U (see FIG. 3) which is to be finally provided. Thereafter, the electrolytic solution is injected into the battery can 11 to thereby impregnate the wound body with the electrolytic solution. Thus, the positive electrode 21, the negative electrode 22, and the separator 23 are each impregnated with the electrolytic solution, and the battery device 20 is fabricated as a result. Thereafter, the battery cover 14 and the safety valve mechanism 30 (the safety cover 31) are placed inside the battery can 11 together with the gasket 15.

Lastly, the open end part 11N and both the battery cover 14 and the safety valve mechanism 30 are crimped to each other with the gasket 15 interposed therebetween at the open end part 11N of the battery can 11, as illustrated in FIG. 1. As a result, the bent part 11P is formed, and the crimp structure 11R is therefore formed. Thereafter, the battery can 11 is pressed in the placing direction V1 by means of a pressing machine. A portion, of the battery can 11, in the vicinity of the recessed part 11UZ is thus deformed toward the inner side to thereby provide the recessed part 11U, as illustrated in FIG. 3. Accordingly, the battery can 11 is closed by the battery cover 14 and the battery cover 14 and other components are fixed to the battery can 11 in a state where the battery device 20 and other components are contained inside the battery can 11. As a result, the secondary battery is assembled.

The assembled secondary battery is charged and discharged. Various conditions including, for example, an environment temperature, the number of times of charging and discharging (the number of cycles), and charging and discharging conditions may be set as desired. A film is thereby formed on a location such as a location on a surface of the negative electrode 22. This brings the secondary battery into an electrochemically stable state. The battery device 20 and other components are thus sealed inside the battery can 11. As a result, the secondary battery of the cylindrical type is completed.

According to the secondary battery, the outer diameter D1 is within the range from 25 mm to 27 mm both inclusive, and the bending proportion R1 is within the range from 8.0% to 10.0% both inclusive. This secures the pressing force F and helps to prevent the bent part 11P from easily becoming wavy even in a large-diameter secondary battery, as described above. The gap between the bent part 11P and the battery cover 14 is thereby more easily sealed by the gasket 15, and sealing strength of the crimp structure 11R therefore improves. Accordingly, the effective operation of the safety valve mechanism 30 is secured. It is therefore possible to achieve superior safety.

In particular, the outer diameter D2 may be within the range from 24 mm to 26 mm both inclusive, and the overlap proportion R2 may be within the range from 4.0% to 6.0% both inclusive. This secures the effective operation of the safety valve mechanism 30 while suppressing the falling off of the battery cover 14 and the leakage of the electrolytic solution even in a large-diameter secondary battery. It is therefore possible to achieve higher effects.

Further, the thickness of the gasket 15 may be gradually reduced as the gasket 15 lies along from the side surface 14SS toward the top surface 14TS. This allows the gap between the bent part 11P and the battery cover 14 to be more easily sealed by the gasket 15 with use of the pressing force F. It is therefore possible to achieve higher effects.

In this case, the crimp angle θ may be within the range from 80° to 90° both inclusive, and the thickness difference DT may be within the range from 0.10 mm to 0.29 mm both inclusive. This allows the external tab to be easily coupled to the battery cover 14 while securing the safety of the secondary battery. It is therefore possible to achieve higher effects.

Further, the thickness T3 may be within the range from 0.27 mm to 0.31 mm both inclusive. This allows the external tab to be easily coupled to the battery cover 14 while securing the battery capacity. It is therefore possible to achieve higher effects.

Further, the total thickness TT may be within the range from 1.0 mm to 1.4 mm both inclusive. This allows the external tab to be easily coupled to the battery cover 14 while securing the battery capacity. It is therefore possible to achieve higher effects.

Further, the arithmetic mean roughness Ra1 may be less than the arithmetic mean roughness Ra2. More specifically, the arithmetic mean roughness Ra1 may be less than or equal to 0.4 μm, and the arithmetic mean roughness Ra2 may be greater than 0.4 μm. This helps to prevent the electrolytic solution from leaking easily and also to prevent the battery can 11 from being dissolved easily. It is therefore possible to achieve higher effects.

Further, the protective layer 16 including asphalt may cover the surface of the gasket 15, and the area density of the protective layer 16 is within the range from 0.060 mg/cm² to 0.100 mg/cm² both inclusive. This secures manufacturability (manufacture efficiency) of the secondary battery while securing the sealing property of the gasket 15. It is therefore possible to achieve higher effects.

Further, the battery cover 14 may include stainless steel. This secures the physical strength of the crimp structure 11R (the battery cover 14). Accordingly, the falling off of the battery cover 14 and the leakage of the electrolytic solution are suppressed even if the internal pressure of the battery can 11 increases. It is therefore possible to achieve higher effects.

Further, the gasket 15 may include polypropylene. This allows the gap between the bent part 11P and the battery cover 14 to be sufficiently sealed while electrically separating the battery can 11 and the battery cover 14 from each other. It is therefore possible to achieve higher effects.

Further, the positive electrode 21 may include the lithium phosphoric acid compound having the olivine crystal structure. This prevents the battery capacity from decreasing easily even if the secondary battery is repeatedly charged and discharged, and also prevents the secondary battery from easily exhibiting the thermal runaway. It is therefore possible to achieve higher effects.

Further, the secondary battery may include a lithium-ion secondary battery. This makes it possible to obtain a sufficient battery capacity stably through the use of insertion and extraction of lithium. It is therefore possible to achieve higher effects.

The configuration of the secondary battery is appropriately modifiable as described below. Note that any two or more of the following series of modifications may be combined with each other.

The separator 23 which is a porous film is used. However, although not specifically illustrated here, a separator of a stacked type including a polymer compound layer may be used instead of the separator 23 which is the porous film.

For example, the separator of the stacked type includes a porous film having two opposed surfaces, and the polymer compound layer disposed on one of or each of the two opposed surfaces of the porous film. A reason for this is that adherence of the separator to each of the positive electrode 21 and the negative electrode 22 improves to suppress the occurrence of misalignment (irregular winding of each of the positive electrode 21, the negative electrode 22, and the separator) of the battery device 20. This helps to prevent the secondary battery from easily swelling even if, for example, the decomposition reaction of the electrolytic solution occurs. The polymer compound layer includes a polymer compound such as polyvinylidene difluoride. A reason for this is that the polymer compound such as polyvinylidene difluoride has superior physical strength and is electrochemically stable.

Note that the porous film, the polymer compound layer, or both may each include one or more kinds of insulating particles. A reason for this is that the insulating particles dissipate heat upon heat generation by the secondary battery, thus improving safety or heat resistance of the secondary battery. Examples of the insulating particles include inorganic particles and resin particles. Specific examples of the inorganic particles include particles of: aluminum oxide, aluminum nitride, boehmite, silicon oxide, titanium oxide, magnesium oxide, and zirconium oxide. Specific examples of the resin particles include particles of acrylic resin and particles of styrene resin.

In a case of fabricating the separator of the stacked type, a precursor solution including, without limitation, the polymer compound and an organic solvent is prepared, following which the precursor solution is applied on one of or each of the two opposed surfaces of the porous film. In this case, insulating particles may be added to the precursor solution.

In the case where the separator of the stacked type is used also, lithium ions are movable between the positive electrode 21 and the negative electrode 22, and similar effects are therefore obtainable.

The electrolytic solution which is a liquid electrolyte is used. However, although not specifically illustrated here, an electrolyte layer which is a gel electrolyte may be used instead of the electrolytic solution.

In the battery device 20 including the electrolyte layer, the positive electrode 21 and the negative electrode 22 are stacked on each other with the separator 23 and the electrolyte layer interposed therebetween, and the stack of the positive electrode 21, the negative electrode 22, the separator 23, and the electrolyte layer is wound. The electrolyte layer is interposed between the positive electrode 21 and the separator 23, and between the negative electrode 22 and the separator 23.

For example, the electrolyte layer includes a polymer compound together with the electrolytic solution. The electrolytic solution is held by the polymer compound in the electrolyte layer. A reason for this is that the leakage of the electrolytic solution is prevented. The configuration of the electrolytic solution is as described above. The polymer compound includes, for example, polyvinylidene difluoride. In a case of forming the electrolyte layer, a precursor solution including, for example, the electrolytic solution, the polymer compound, and an organic solvent is prepared, following which the precursor solution is applied on one side or both sides of the positive electrode 21 and on one side or both sides of the negative electrode 22.

In a case where the electrolyte layer is used also, lithium ions are movable between the positive electrode 21 and the negative electrode 22 via the electrolyte layer, and similar effects are therefore obtainable.

Next, a description is given of applications (application examples) of the above-described secondary battery according to an embodiment.

The applications of the secondary battery are not particularly limited. The secondary battery used as a power source serves as a main power source or an auxiliary power source of, for example, electronic equipment and an electric vehicle. The main power source is preferentially used regardless of the presence of any other power source. The auxiliary power source is used in place of the main power source, or is switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems or industrial battery systems for accumulation of electric power for a situation such as emergency. The above-described applications may each use one secondary battery, or may each use multiple secondary batteries.

The battery packs may each include a single battery, or may each include an assembled battery. The electric vehicle is a vehicle that operates (travels) using the secondary battery as a driving power source, and may be a hybrid automobile that is additionally provided with a driving source other than the secondary battery. In an electric power storage system for home use, electric power accumulated in the secondary battery which is an electric power storage source may be utilized for using, for example, home appliances.

An application example of the secondary battery will now be described in detail. The configuration of the application example described below is merely an example, and is appropriately modifiable.

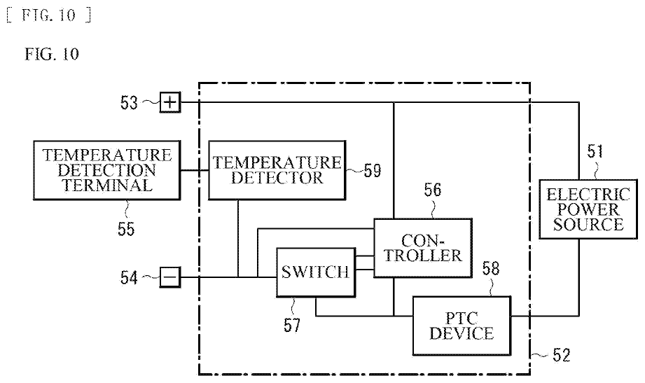

FIG. 10 illustrates a block configuration of a battery pack. The battery pack described here is a battery pack (a so-called soft pack) including one secondary battery, and is to be mounted on, for example, electronic equipment typified by a smartphone.

As illustrated in FIG. 10, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to outside via the positive electrode terminal 53 and the negative electrode terminal 54, and is thus chargeable and dischargeable. The circuit board 52 includes a controller 56, a switch 57, a thermosensitive resistive device (a PTC device) 58, and a temperature detector 59. However, the PTC device 58 may be omitted.

The controller 56 includes, for example, a central processing unit (CPU) and a memory, and controls an overall operation of the battery pack. The controller 56 detects and controls a use state of the electric power source 51 on an as-needed basis.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. For example, the overcharge detection voltage is 4.2 V±0.05 V and the overdischarge detection voltage is 2.4 V±0.1 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). The charging and discharging currents are detected based on an ON-resistance of the switch 57.

The temperature detector 59 includes a temperature detection device such as a thermistor. The temperature detector 59 measures a temperature of the electric power source 51 using the temperature detection terminal 55, and outputs a result of the temperature measurement to the controller 56. The result of the temperature measurement to be obtained by the temperature detector 59 is used, for example, in a case where the controller 56 performs charge/discharge control upon abnormal heat generation or in a case where the controller 56 performs a correction process upon calculating a remaining capacity.

### EXAMPLES

A description is given of Examples of the present technology according to an embodiment.

### Examples 1-1 to 1-4 to Comparative Examples 1-1 to 1-4

Secondary batteries were fabricated, following which the secondary batteries were each evaluated for a battery characteristic.

### [Fabrication of Secondary Battery]

The lithium-ion secondary batteries of the cylindrical type illustrated in FIGS. 1 to 5 (having a diameter that equaled the outer diameter D1 (mm) and a length of 65 mm) were fabricated in accordance with the following procedure.

### (Fabrication of Positive Electrode)

First, 94 parts by mass of the positive electrode active material (LiFePO₄), 3 parts by mass of the positive electrode binder (polyvinylidene difluoride), and 3 parts by mass of the positive electrode conductor (graphite) were mixed with each other to thereby obtain a positive electrode mixture. Thereafter, the positive electrode mixture was put into a solvent (N-methyl-2-pyrrolidone which is the organic solvent), following which the organic solvent was stirred to thereby prepare a positive electrode mixture slurry in a paste form. Thereafter, the positive electrode mixture slurry was applied on the two opposed surfaces of the positive electrode current collector 21A (a band-shaped aluminum foil having a thickness of 15 μm) by means of a coating apparatus, following which the applied positive electrode mixture slurry was dried to thereby form the positive electrode active material layers 21B. Lastly, the positive electrode active material layers 21B were compression-molded by means of a roll pressing machine.

### (Fabrication of Negative Electrode)

First, 95 parts by mass of the negative electrode active material (graphite), 3 parts by mass of the negative electrode binder (polyvinylidene difluoride), and 2 parts by mass of the negative electrode conductor (carbon black) were mixed with each other to thereby obtain a negative electrode mixture. Thereafter, the negative electrode mixture was put into a solvent (N-methyl-2-pyrrolidone which is the organic solvent), following which the organic solvent was stirred to thereby prepare a negative electrode mixture slurry in a paste form. Thereafter, the negative electrode mixture slurry was applied on the two opposed surfaces of the negative electrode current collector 22A (a band-shaped copper foil having a thickness of 15 μm) by means of a coating apparatus, following which the applied negative electrode mixture slurry was dried to thereby form the negative electrode active material layers 22B. Lastly, the negative electrode active material layers 22B were compression-molded by means of a roll pressing machine.

### (Preparation of Electrolytic Solution)

The electrolyte salt (LiPF₆) was added to the solvent (ethylene carbonate, ethyl methyl carbonate, and dimethyl carbonate), following which the solvent was stirred. In this case, a mixture ratio (a weight ratio) of the solvent between ethylene carbonate, ethyl methyl carbonate, and dimethyl carbonate was set to 20:20:60, and a content of the electrolyte salt was set to 1 mol/kg with respect to the solvent.

### (Assembly of Secondary Battery)

First, the positive electrode lead 25 including aluminum was welded to the positive electrode 21 (the positive electrode current collector 21A), and the negative electrode lead 26 including nickel was welded to the negative electrode 22 (the negative electrode current collector 22A). Thereafter, the positive electrode 21 and the negative electrode 22 were stacked on each other with the separator 23 (a porous polyethylene film having a thickness of 16 μm) interposed therebetween, following which the stack of the positive electrode 21, the negative electrode 22, and the separator 23 was wound to thereby fabricate the wound body having the center space 20C. Thereafter, the center pin 24 was placed in the center space 20C of the wound body.

Thereafter, the safety valve mechanism 30 that included the safety cover 31 including aluminum (and having the thickness T5), the disk holder 32 including polypropylene, the stripper disk 33 including aluminum, and the sub-disk 34 including aluminum was prepared. In this case, the stripper disk 33 having six openings 33K was used.

Thereafter, the wound body was placed, together with the pair of insulating plates 12 and 13, inside the battery can 11. The battery can 11 included iron and was plated with nickel. The battery can 11 had the outer diameter D1 and included the bent part 11P having the thickness T3. The outer diameter D1 (mm) was as presented in Table 1. In this case, the positive electrode lead 25 was welded to the safety valve mechanism 30 (the sub-disk 34), and the negative electrode lead 26 was welded to the battery can 11. Thereafter, the battery can 11 was processed by means of a beading machine to thereby provide the recessed part 11UZ (having the depth PZ). Thereafter, the electrolytic solution was injected into the battery can 11 by a reduced-pressure method. The wound body was thus impregnated with the electrolytic solution. As a result, the battery device 20 was fabricated.

Thereafter, asphalt was added to a solvent (ethylcyclohexane which was the organic solvent), following which the solvent was stirred to thereby prepare a coating solution. Thereafter, the coating solution was applied to the surface of the gasket 15 (including polypropylene and having the thicknesses T1 and T2), following which the applied coating solution was dried to thereby form the protective layer 16.

Lastly, the open end part 11N of the battery can 11 and both the battery cover 14 (having the outer diameter D2 and the thickness 4) and the safety valve mechanism 30 were crimped to each other with the gasket 15, which had the surface covered with the protective layer 16, interposed between the open end part 11N and both the battery cover 14 and the safety valve mechanism 30, to thereby form the crimp structure 11R. Thereafter, the battery can 11 was pressed by means of a pressing machine to thereby form the recessed part 11U (having the depth P).

In a case of forming the crimp structure 11R, each of the length L1 and the bending proportion R1 was changed by adjusting, for example, a bending amount of the bent part 11P. Each of the length L1 and the bending proportion R1 was as presented in Table 1.

In such a manner, the open end part 11N of the battery can 11 was closed by the battery cover 14, and the battery device and other components were placed inside the battery can 11. As a result, the lithium-ion secondary battery of the cylindrical type was assembled.

### (Stabilization of Secondary Battery)

The secondary battery was charged and discharged for one cycle in an ambient temperature environment (at a temperature of 23° C.). Upon charging, the secondary battery was charged with a constant current of 0.1 C until a voltage reached 4.2 V, and was thereafter charged with the constant voltage of 4.2 V until a current reached 0.05 C. Upon the discharging, the secondary battery was discharged with a constant current of 0.1 C until the voltage reached 3.0 V. Note that 0.1 C is a value of a current that causes a battery capacity (a theoretical capacity) to be completely discharged in 10 hours, and 0.05 C is a value of a current that causes the battery capacity to be completely discharged in 20 hours.

In this manner, the state of the secondary battery was electrochemically stabilized. The lithium-ion secondary battery of the cylindrical type was thus completed.

### [Evaluation of Battery Characteristic]

Evaluation of the secondary batteries for their battery characteristics (a crimp characteristic and a drop durability characteristic) by the following procedure revealed the results presented in Table 1.

### (Crimp Characteristic)

A state of the crimp structure 11R (the battery cover 14) was observed after the secondary battery was completed, to thereby measure a deformation amount (a shifting amount: mm) of the battery cover 14. The deformation amount of the battery cover 14 was an index for evaluating the crimp characteristic.

In the crimp structure 11R, when the bending proportion R1 increased in accordance with an increase in the length L1, the middle part of the battery cover 14 was easily deformed toward the middle part of the safety cover 31. The crimping of the bent part 11P and the battery cover 14 to each other with the gasket 15 interposed therebetween was therefore loosened easily. Accordingly, the electrolytic solution easily leaked through the gap produced between the gasket 15 and the bent part 11P, and the electrolytic solution also easily leaked through the gap produced between the gasket 15 and the battery cover 14.

### (Drop Durability Characteristic)

A drop test of the secondary battery was performed to determine a drop-test pass rate (%). The drop-test pass rate was an index for evaluating the drop durability characteristic.

Specifically, first, the secondary battery was charged until a voltage reached 4.4 V. Thereafter, a process of dropping the charged secondary battery onto the ground with the crimp structure 11R (the bent part 11P) facing the ground was performed 30 times. Thus, whether an issue was caused by an impact at the time of dropping was visually checked. The “issue” referred to, for example, the falling off of the battery cover 14 or the leakage of the electrolytic solution. In a case where an issue was not caused even for once, it was comprehensively determined that no issue was caused. In a case where an issue was caused at least for once, it was comprehensively determined that an issue was caused. In this case, 100 secondary batteries were used to repeatedly perform the above-described determination operation 100 times (the number of times of the drop test=100 times). Lastly, the above-described drop-test pass rate was calculated based on the following calculation expression: (number of times with no issue caused/100 times)×100.

TABLE 1

| | Outer | | | | |
|---|---|---|---|---|---|
| | diameter | | Bending | | Drop-test |
| | D1 | Length | proportion | Deformation | pass rate |
| | (mm) | L1 (mm) | R1 (%) | amount (mm) | (%) |
| Comparative | 25 | 1.8 | 7.2 | 0.0 | 65 |
| example 1-1 | | | | | |
| Example 1-1 | 25 | 2.0 | 8.0 | 0.0 | 95 |
| Example 1-2 | 25 | 2.5 | 10.0 | 0.0 | 100 |
| Comparative | 25 | 2.8 | 11.2 | 0.5 | 60 |
| example 1-2 | | | | | |
| Comparative | 27 | 2.0 | 7.4 | 0.0 | 60 |
| example 1-3 | | | | | |
| Example 1-3 | 27 | 2.2 | 8.0 | 0.0 | 90 |
| Example 1-4 | 27 | 2.7 | 10.0 | 0.0 | 95 |
| Comparative | 27 | 3.0 | 11.1 | 0.8 | 50 |
| example 1-4 | | | | | |

As presented in Table 1, each of the deformation amount and the drop-test pass rate varied depending on the bending proportion R1 (the outer diameter D1 and the length L1). Specifically, in the large-diameter secondary battery having the outer diameter D1 within the range from 25 mm to 27 mm both inclusive, in a case where the bending proportion R1 was within the appropriate range (R1=8.0% to 10.0%), a high drop-test pass rate was achieved while the deformation amount was suppressed, as compared with a case where the bending proportion R1 was out of the appropriate range.

### Examples 2-1 to 2-8

As presented in Table 2, secondary batteries were fabricated by a similar procedure except that the outer diameter D2 (mm), the length L2 (mm), and the overlap proportion R2 (%) were each set, and were thereafter evaluated for their battery characteristics (a gas releasing characteristic and the drop durability characteristic).

Here, as described above, the gas releasing characteristic was evaluated instead of the crimp characteristic. In this case, a heating test of the secondary battery was performed to measure a releasing pressure (kgf/cm²) of the secondary battery. The releasing pressure of the secondary battery was an index for evaluating the gas releasing characteristic. In the heating test, the middle part of the secondary battery (the battery can 11) was heated until the internal pressure of the battery can 11 was released owing to the operation of the safety valve mechanism 30 (the presence of the opening 31K), to thereby measure the internal pressure (the releasing pressure) at the time when the internal pressure of the battery can 11 was released. In this case, the crimp structure 11R was destroyed due to deformation of the bent part 11P. Therefore, the battery cover 14 fell off from the battery can 11, which allowed the internal pressure of the battery can 11 to be released.

TABLE 2

| | Outer | | | | |
|---|---|---|---|---|---|
| | diameter | | Overlap | Releasing | Drop-test |
| | D2 | Length | proportion | pressure | pass rate |
| | (mm) | L2 (mm) | R2 (%) | (kgf/cm²) | (%) |
| Example 2-1 | 24 | 0.85 | 3.5 | 60 | 100 |
| Example 2-2 | 24 | 0.95 | 4.0 | 70 | 100 |
| Example 2-3 | 24 | 1.45 | 6.0 | 80 | 90 |
| Example 2-4 | 24 | 1.93 | 8.0 | 100 | 60 |
| Example 2-5 | 26 | 0.90 | 3.5 | 55 | 100 |
| Example 2-6 | 26 | 1.05 | 4.0 | 65 | 100 |
| Example 2-7 | 26 | 1.55 | 6.0 | 75 | 90 |
| Example 2-8 | 26 | 2.08 | 8.0 | 100 | 55 |

As presented in Table 2, if the overlap proportion R2 was within the appropriate range (R2=4.0% to 6.0%) in the large-diameter secondary battery having the outer diameter D2 within the range from 24 mm to 26 mm both inclusive, a higher drop-test pass rate was achieved while the releasing pressure was secured.

### Examples 3-1 to 3-9

As presented in Table 3, secondary batteries were fabricated by a similar procedure except that the crimp angle θ(°), the thicknesses T1 and T2 (mm), and the thickness difference DT (mm) were each set, and were thereafter evaluated for their battery characteristics (the drop durability characteristic).

TABLE 3

| | | | | Thickness | |
|---|---|---|---|---|---|
| | Crimp | | | difference | Drop-test |
| | angle θ | Thickness | Thickness | DT | pass rate |
| | (°) | T1 (mm) | T2 (mm) | (mm) | (%) |
| Example 3-1 | 63 | 0.68 | 0.25 | 0.43 | 70 |
| Example 3-2 | 70 | 0.66 | 0.37 | 0.29 | 85 |
| Example 3-3 | 80 | 0.66 | 0.37 | 0.29 | 100 |
| Example 3-4 | 80 | 0.47 | 0.37 | 0.10 | 95 |
| Example 3-5 | 90 | 0.66 | 0.37 | 0.29 | 95 |
| Example 3-6 | 90 | 0.47 | 0.37 | 0.10 | 90 |
| Example 3-7 | 90 | 0.66 | 0.58 | 0.08 | 80 |
| Example 3-8 | 90 | 0.66 | 0.25 | 0.41 | 80 |
| Example 3-9 | 91 | 0.66 | 0.25 | 0.41 | 78 |

As presented in Table 3, if the crimp angle θ was within the appropriate range (θ=80° to 90°) and if the thickness difference DT was within the appropriate range (DT=0.10 mm to 0.29 mm), a higher drop-test pass rate was achieved.

### Examples 4-1 to 4-6

As presented in Table 4, secondary batteries were fabricated by a similar procedure except that the thickness T3 (mm) was set, and were thereafter evaluated for their battery characteristics (the gas releasing characteristic and a battery capacity characteristic).

Here, as described above, the battery capacity characteristic was evaluated instead of the crimp characteristic. In this case, the secondary battery was charged and discharged in an ambient temperature environment (at a temperature of 23° C.) to measure a battery capacity (Ah). The battery capacity was an index for evaluating the battery capacity characteristic. Charging and discharging conditions were similar to those for the stabilization of the secondary battery described above.

TABLE 4

| | Thickness | Releasing | Battery |
|---|---|---|---|
| | T3 | pressure | capacity |
| | (mm) | (kgf/cm²) | (Ah) |
| Example 4-1 | 0.25 | 65 | 3.007 |
| Example 4-2 | 0.27 | 70 | 3.004 |
| Example 4-3 | 0.29 | 72 | 3.000 |
| Example 4-4 | 0.31 | 79 | 2.996 |
| Example 4-5 | 0.33 | 86 | 2.993 |
| Example 4-6 | 0.35 | 93 | 2.990 |

As presented in Table 4, if the thickness T4 was within the appropriate range (T3=0.27 mm to 0.31 mm), a high battery capacity was achieved while the releasing pressure was secured.

### Examples 5-1 to 5-5

As presented in Table 5, secondary batteries were fabricated by a similar procedure except that the thicknesses T4 and T5 (mm) and the total thickness TT (mm) were each set, and were thereafter evaluated for their battery characteristics (the gas releasing characteristic and the battery capacity characteristic).

TABLE 5

| | | | Total | Releasing | Battery |
|---|---|---|---|---|---|
| | Thickness | Thickness | thickness | pressure | capacity |
| | T4 (mm) | T5 (mm) | TT (mm) | (kgf/cm²) | (Ah) |
| Example 5-1 | 0.5 | 0.3 | 0.8 | 55 | 3.056 |
| Example 5-2 | 0.7 | 0.3 | 1.0 | 65 | 3.034 |
| Example 5-3 | 0.7 | 0.5 | 1.2 | 72 | 3.000 |
| Example 5-4 | 0.9 | 0.5 | 1.4 | 79 | 2.977 |
| Example 5-5 | 0.9 | 0.7 | 1.6 | 85 | 2.944 |

As presented in Table 5, if the total thickness TT was within the appropriate range (TT=1.0 mm to 1.4 mm), a high battery capacity was achieved while the releasing pressure was secured.

### Examples 6-1 to 6-6

As presented in Table 6, secondary batteries were fabricated by a similar procedure except that the arithmetic mean roughnesses Ra1 and Ra2 (μm) were set, and were thereafter evaluated for their battery characteristics (the drop durability characteristic and a withstand voltage characteristic).

Here, as described above, the withstand voltage characteristic was evaluated instead of the crimp characteristic. In this case, first, the secondary battery was charged and discharged in an ambient temperature environment (at a temperature of 23° C.). Charging and discharging conditions were similar to those for the stabilization of the secondary battery described above, except that the voltage at the time of discharging was changed to 3.25 V. Thereafter, the secondary battery was left to stand in the same environment (for a leaving time of one month), following which a determination was made as to whether the voltage of the left secondary battery decreased to 3.2 V or lower. In this case, 10-thousand secondary batteries were used to repeatedly perform the above-described determination process 10-thousand times. Lastly, an open-circuit voltage (OCV) defective rate (%) was calculated based on the following calculation expression: OCV defective rate=(number of secondary batteries with a decrease in voltage/10000)×100. The OCV defective rate was an index for evaluating the withstand voltage characteristic.

TABLE 6

| | Arithmetic | Arithmetic | | OCV |
|---|---|---|---|---|
| | mean | mean | Drop-test | defective |
| | roughness | roughness | pass rate | rate |
| | Ra1 (μm) | Ra2 (μm) | (%) | (%) |
| Example 6-1 | 0.3 | 1.0 | 95 | 0.10 |
| Example 6-2 | 0.01 | 0.5 | 100 | 0.25 |
| Example 6-3 | 0.4 | 2.0 | 90 | 0.45 |
| Example 6-4 | 0.4 | 0.5 | 90 | 0.30 |
| Example 6-5 | 1.0 | 1.0 | 85 | 0.10 |
| Example 6-6 | 0.3 | 0.3 | 93 | 5.00 |

As presented in Table 6, if the arithmetic mean roughness Ra1 was less than the arithmetic mean roughness Ra2, a higher drop-test pass rate was obtained while the OCV defective rate was suppressed. In this case, if the arithmetic mean roughnesses Ra1 and Ra2 were within the respective appropriate ranges (Ra1≤0.4 μm and Ra2>0.4 μm), the drop-test pass rate was sufficiently high and the OCV defective number was sufficiently small.

### Examples 7-1 to 7-7

As presented in Table 7, secondary batteries were fabricated by a similar procedure except that a concentration (%) of the coating solution was set to thereby set the area density (mg/cm²) of the protective layer 16, and were thereafter evaluated for their battery characteristics (the drop durability characteristic and a battery assembly characteristic).

Here, as described above, the battery assembly characteristic was evaluated instead of the crimp characteristic. In this case, an assemble test of the secondary battery was performed while the gasket 15 provided with the protective layer 16 was automatically conveyed, to thereby calculate an operating rate (%) based on the following calculation expression: (time during which assembly of secondary batteries was actually performable/time for which secondary battery assembly machine was to operate per day)×100. The operating rate was an index for evaluating the battery assembly characteristic. In this case, if the conveying of the gasket 15 along an automatic conveying path failed due to the adhesiveness of the protective layer 16, that is, if some parts were stuck along the automatic conveying path due to the adhesiveness of the protective layer 16, the assembly of the secondary batteries had to be temporarily stopped in order to improve the failure in conveying the gasket 15. This shortened the “time during which assembly of secondary batteries was actually performable” described above.

TABLE 7

| | | Formation | | |
|---|---|---|---|---|
| | Concentration | amount | Drop-test | Operating |
| | (%) | (mg/cm²) | pass rate (%) | rate (%) |
| Example 7-1 | 1.0 | 0.030 | 70 | 98 |
| Example 7-2 | 1.5 | 0.045 | 80 | 98 |
| Example 7-3 | 2.0 | 0.060 | 90 | 95 |
| Example 7-4 | 2.5 | 0.075 | 90 | 95 |
| Example 7-5 | 3.0 | 0.090 | 95 | 90 |
| Example 7-6 | 3.5 | 0.100 | 100 | 90 |
| Example 7-7 | 4.0 | 0.120 | 100 | 85 |

As presented in Table 7, if the area density of the protective layer 16 was within the appropriate range (the formation amount=0.060 mg/cm′ to 0.100 mg/cm²), a high operating rate was achieved while a high drop-test pass rate was achieved.

### Examples 8-1 to 8-3

As presented in Table 8, secondary batteries were fabricated by a similar procedure except that a material included in the battery can 11 was set, and were thereafter evaluated for their battery characteristics (the drop durability characteristic).

Here, as the material included in the battery can 11, stainless steel (SUS430 and SUS304) and iron (SPCC) were used. For reference, Table 8 presents a tensile strength (N/mm²) of the material included in the battery can 11 together.

TABLE 8

| | | | Drop-test |
|---|---|---|---|
| | | Tensile strength | pass rate |
| | Material | (N/mm²) | (%) |
| Example 8-1 | SUS430 | 450 | 100 |
| Example 8-2 | SUS304 | 520 | 95 |
| Example 8-3 | SPCC | 270 | 80 |

As presented in Table 8, if the battery can 11 included stainless steel, a higher drop-test pass rate was achieved.

Based upon the results presented in Tables 1 to 8, both the crimp characteristic and the drop durability characteristic improved if the outer diameter D1 was within the range from 25 mm to 27 mm both inclusive and the bending proportion R1 was within the range from 8.0% to 10.0% both inclusive. The large-diameter secondary battery therefore achieved superior safety.

Although the present technology has been described above with reference to one or more embodiments including Examples, the present technology is not limited thereto, and is therefore modifiable in a variety of suitable ways.

For example, the description has been given of the case where the battery device has a device structure of a wound type. However, the device structure of the battery device is not particularly limited, and may thus be a stacked type in which the positive electrode and the negative electrode are stacked on each other, a zigzag folded type in which the positive electrode and the negative electrode are folded in a zigzag manner, or any other type.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

Note that the effects described herein are mere examples and non-limiting. Further, any other suitable effect may be achieved.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a container member including a bent part defining an open end part;
a battery device contained inside the container member;
a cover member that closes the open end part; and
a sealing member interposed between the bent part and the cover member, wherein
the cover member includes a first bottom surface, a first top surface, and a first side surface, the first bottom surface being opposed to the battery device, the first top surface being positioned on an opposite side to the first bottom surface, the first side surface being coupled to each of the first bottom surface and the first top surface,
the bent part is provided along the first bottom surface, the first side surface, and the first top surface in this order and includes a tip part, the tip part provided along the first side surface and the first top surface in this order,
the container member has an outer diameter of greater than or equal to 25 millimeters and less than or equal to 27 millimeters in an intersecting direction, the outer diameter being defined based on the bent part, the intersecting direction intersecting with a placing direction in which the battery device is placed into the container member, and
a proportion of a length of the tip part in the intersecting direction to the outer diameter of the container member is greater than or equal to 8.0 percent and less than or equal to 10.0 percent.

2. The secondary battery according to claim 1, wherein
the tip part and the cover member overlap with each other in the placing direction,
the cover member has an outer diameter of greater than or equal to 24 millimeters and less than or equal to 26 millimeters in the intersecting direction, and
a proportion of a length, in the intersecting direction, of a range in which the tip part and the cover member overlap with each other to the outer diameter of the cover member is greater than or equal to 4.0 percent and less than or equal to 6.0 percent.

3. The secondary battery according to claim 1, wherein
the sealing member is provided along the first side surface and the first top surface in this order, and
the sealing member has a thickness that is gradually reduced as the sealing member is provided from the first side surface toward the first top surface.

4. The secondary battery according to claim 3, further comprising
an adjacent member disposed adjacent to the first bottom surface, wherein
the adjacent member includes a second bottom surface, a second top surface, and a second side surface, the second bottom surface being opposed to the battery device, the second top surface being adjacent to the first bottom surface, the second side surface being coupled to each of the second bottom surface and the second top surface,
the bent part is provided along the second bottom surface, the second side surface, the first side surface, and the first top surface in this order,
the tip part includes a first tip part and a second tip part, the first tip part extending along the first side surface, the second tip part extending along the first top surface and being coupled to the first tip part,
an angle defined by a direction in which the first tip part extends and a direction in which the second tip part extends is greater than or equal to 80 degrees and less than or equal to 90 degrees, and
a thickness difference is greater than or equal to 0.10 millimeters and less than or equal to 0.29 millimeters, the thickness difference resulting from subtracting a thickness of the sealing member at a position corresponding to a tip of the bent part in the intersecting direction from a thickness of the sealing member at a position corresponding to the second bottom surface in the placing direction.

5. The secondary battery according to claim 1, wherein the tip part has a thickness of greater than or equal to 0.27 millimeters and less than or equal to 0.31 millimeters.

6. The secondary battery according to claim 1, further comprising
an adjacent member disposed adjacent to the first bottom surface, wherein
the adjacent member includes a second bottom surface, a second top surface, and a second side surface, the second bottom surface being opposed to the battery device, the second top surface being adjacent to the first bottom surface, the second side surface being coupled to each of the second bottom surface and the second top surface,
the bent part is provided along the second bottom surface, the second side surface, the first side surface, and the first top surface in this order, and
a total thickness resulting from adding a thickness of the cover member and a thickness of the adjacent member together is greater than or equal to 1.0 millimeter and less than or equal to 1.4 millimeters.

7. The secondary battery according to claim 1, wherein
the container member includes a recessed part at which the bent part is folded back in part along the first bottom surface, and
an arithmetic mean roughness Ra of an inner wall, of the container member, on a side closer to the cover member relative to a position of the recessed part as a reference in the placing direction is less than an arithmetic mean roughness Ra of an inner wall, of the container member, on a side farther from the cover member relative to the position of the recessed part as the reference in the placing direction.

8. The secondary battery according to claim 7, wherein
the arithmetic mean roughness Ra of the inner wall, of the container member, on the side closer to the cover member is less than or equal to 0.4 micrometers, and
the arithmetic mean roughness Ra of the inner wall, of the container member, on the side farther from the cover member is greater than 0.4 micrometers.

9. The secondary battery according to any claim 1, further comprising
a protective layer covering a surface of the sealing member and including asphalt, wherein
the protective layer has an area density of greater than or equal to 0.060 milligrams per square centimeter and less than or equal to 0.100 milligrams per square centimeter.

10. The secondary battery according to claim 1, wherein the cover member includes stainless steel.

11. The secondary battery according to claim 1, wherein the sealing member includes polypropylene.

12. The secondary battery according to claim 1, wherein
the battery device includes a positive electrode, and
the positive electrode includes a lithium phosphoric acid compound having an olivine crystal structure.

13. The secondary battery according to claim 1, wherein the secondary battery comprises a lithium-ion secondary battery.
